(19) United States
(12) Patent Application Publication
(10) Pub. No.: US 2026/0098439 A1
(43) Pub. Date: Apr. 9, 2026

(54) STOREFRONT FENESTRATION SYSTEMS

(71) Applicant: Arconic Technologies LLC, Pittsburgh, PA (US)

(72) Inventors: Gregory B. MCKENNA, Cumming, GA (US); Christopher R. HARTWELL, Suwanee, GA (US)

(73) Assignee: Arconic Technologies LLC, Pittsburgh, PA (US)

(21) Appl. No.: 19/323,588

(22) Filed: Sep. 9, 2025

Related U.S. Application Data
(60) Provisional application No. 63/704,938, filed on Oct. 8, 2024.

(51) Int. Cl. E06B 1/38; E06B 1/60; E06B 1/70; E06B 7/14

(52) U.S. Cl. CPC E06B 1/38; E06B 1/6038; E06B 1/702; E06B 7/14

(57) ABSTRACT

A fenestration system includes a back angle anchor providing a first anchor portion and a second anchor portion extending from the first anchor portion and providing an attachment receptor, the back angle anchor being securable to an underlying substrate at the first anchor portion, a subsill providing a first subsill portion and a second subsill portion extending from the first subsill portion, and an anchor hook extending from the second subsill portion and defining a subsill cavity sized to receive the attachment receptor. The subsill is attached to the back angle anchor using one or more mechanical fasteners penetrating the anchor hook and received within the attachment receptor, and the mechanical fasteners do not penetrate the first or second subsill portions.

### BACKGROUND

Storefront fenestration systems are non-load-bearing walls defined as a system of doors and glazing panels (e.g., windows) in which vertical framing members run between a substrate (e.g., a concrete slab, the floor, etc.) and a structure above (e.g., a header). Typical storefront fenestration systems usually serve as a business'entrance and typically include a plurality of windows and at least one door. The storefront fenestration is often attached directly to the substrate and is exposed to exterior elements and the outside environment.

Common storefront fenestration systems include a subsill that is directly anchored to the underlying substrate using multiple mechanical fasteners (e.g., screws) applied about the perimeter of the storefront. The fasteners, however, commonly penetrate the subsill and any membrane (e.g., air vapor barrier) or sub flashing that might be located below, thereby increasing the possibility of water leakage. To help prevent leakage, storefront installers typically apply a silicone sealant over the heads of the mechanical fasteners, thereby diverting any water around the fasteners. However, application of the silicone sealant is subject to user error and may not be properly or adequately applied, thus resulting in leak paths over time.

To avoid penetrating the subsill, more recent storefront fenestration systems include a back angle anchor that is anchored to the substrate within the interior of the building. Once the back angle anchor is properly anchored, the subsill is then anchored to the back angle anchor. The subsill, however, is commonly anchored to the back angle anchor by penetrating the air vapor barrier, which creates a weak point in the seal if the penetration is not perfectly sealed, thereby decreasing the water performance of the system.

What is needed is an improved storefront fenestration system that is installed without penetrating the subsill or the air vapor barrier when anchoring to the underlying substrate.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include a fenestration system that includes a back angle anchor providing a first anchor portion and a second anchor portion extending from the first anchor portion and providing an attachment receptor, the back angle anchor being securable to an underlying substrate at the first anchor portion, a subsill providing a first subsill portion and a second subsill portion extending from the first subsill portion, and an anchor hook extending from the second subsill portion and defining a subsill cavity sized to receive the attachment receptor, wherein the subsill is attached to the back angle anchor using one or more mechanical fasteners penetrating the anchor hook and received within the attachment receptor, and wherein the subsill is anchorable to the substrate via the back angle anchor without penetrating the first or second subsill portions. In a further embodiment, the fenestration includes a building membrane arrangeable between the subsill and the substrate and including a membrane section interposing the second anchor portion and the second subsill portion, wherein the subsill is anchorable to the substrate via the back angle anchor without penetrating the building membrane. In another further embodiment, the substrate comprises a first substrate portion made of a first material and a second substrate portion made of a second material different from the first material, the fenestration system further comprising a layer of insulation laterally interposing the first and second substrate portions, wherein the membrane section comprises a first membrane section, and the building membrane further includes a second membrane section interposing the first substrate portion and the layer of insulation. In another further embodiment, the subsill is arranged to extend across portions of each of the first and second substrate portions. In another further embodiment, the anchor hook comprises a first extension extending from the second subsill portion and a second extension extending from the first extension. In another further embodiment, the second extension defines a vertical slot sized to receive the one or more mechanical fasteners, the vertical slot allowing a height of the subsill to be adjusted relative to the back angle anchor prior to securing the one or more mechanical fasteners. In another further embodiment, the fenestration system includes a stool trim operatively coupleable to the anchor hook and the back angle anchor and thereby hiding attachment between the anchor hook and the attachment receptor. In another further embodiment, the stool trim includes a stool base, and a stool leg extending from the stool base and operatively coupleable to an anchor leg extending from the first anchor portion with one or more additional mechanical fasteners. In another further embodiment, the stool leg defines a vertical slot sized to receive the one or more additional mechanical fasteners, the vertical slot allowing a height of the subsill to be adjusted relative to the back angle anchor prior to securing the one or more additional mechanical fasteners. In another further embodiment, the fenestration system further includes brake metal flashing arrangeable on an exterior of the system and including an end operatively coupleable to the first subsill portion. In another further embodiment, the fenestration system further includes a fenestration operatively couplable to the subsill and receivable within a space cooperatively defined by the first and second subsill portions. In another further embodiment, the attachment receptor comprises an elongate channel extending a longitudinal length of the subsill. In another further embodiment, the subsill comprises a composite profile such that the first portion includes a first section, a second section, and a thermal break that operatively couples the first and second sections.

Embodiments disclosed herein may further include a method of assembling a fenestration system, the method including securing a back angle anchor to an underlying substrate, the back angle anchor providing a first anchor portion secured to the substrate and a second anchor portion extending from the first anchor portion and providing an attachment receptor, arranging a subsill atop the substrate, the subsill providing a first subsill portion, a second subsill portion extending from the first subsill portion, and an anchor hook extending from the second subsill portion and defining a subsill cavity. The method may further include receiving the attachment receptor into the subsill cavity as the subsill is arranged atop the substrate, and attaching the subsill to the back angle anchor using one or more mechanical fasteners penetrating the anchor hook and received within the attachment receptor, wherein the subsill is anchored to the substrate via the back angle anchor without penetrating the first or second subsill portions. In a further embodiment, the method further includes arranging a building membrane between the subsill and the substrate, and arranging a membrane section of the building membrane between the second anchor portion and the second subsill portion, wherein the subsill is anchored to the substrate via the back angle anchor without penetrating the building membrane. In another further embodiment, the anchor hook comprises a first extension extending from the second subsill portion and a second extension extending from the first extension, and wherein the second extension defines a vertical slot sized to receive the one or more mechanical fasteners, the method further comprising adjusting a height of the subsill relative to the back angle anchor, and securing the one or more mechanical fasteners to the attachment receptor via the vertical slot once the height is adjusted. In another further embodiment, the method further includes coupling a stool trim to the anchor hook and the back angle anchor and thereby hiding attachment between the anchor hook and the attachment receptor. In another further embodiment, wherein the stool trim includes a stool base, and a stool leg extending from the stool base and defining a vertical slot, and wherein coupling the stool trim to the anchor hook and the back angle anchor comprises adjusting a height of the subsill relative to the back angle anchor, and securing one or more additional mechanical fasteners to an anchor leg extending from the first anchor portion via the vertical slot and once the height is adjusted. In another further embodiment, the method further includes securing brake metal flashing to the first subsill portion on an exterior of the system. In another further embodiment, the method further includes receiving a fenestration within a space cooperatively defined by the first and second subsill portions, and operatively coupling the fenestration to the subsill.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIGS. 1A and 1B are schematic side views of prior art storefront fenestration systems.

FIG. 2 is a schematic side view of an example storefront fenestration system, in accordance with the principles of the present disclosure.

FIG. 3 is an isometric view of the system of FIG. 2, according to one or more embodiments of the disclosure.

FIG. 4 is another schematic side view of the system of FIG. 2, according to one or more additional embodiments of the present disclosure.

### DETAILED DESCRIPTION

The present disclosure is related to fenestration systems and, more particularly, to storefront fenestration systems that can be anchored to an underlying substrate without penetrating the building membrane.

Embodiments described herein disclose a fenestration system, such as a storefront fenestration system, that includes a back angle anchor providing a first anchor portion and a second anchor portion extending from the first anchor portion and providing an attachment receptor, the back angle anchor being securable to an underlying substrate at the first anchor portion. A subsill provides a first subsill portion and a second subsill portion extending from the first subsill portion, and an anchor hook extends from the second subsill portion and defines a subsill cavity sized to receive the attachment receptor. The subsill can be attached to the back angle anchor using one or more mechanical fasteners that penetrate the anchor hook and are received within the attachment receptor. Accordingly, the subsill is anchorable to the substrate via the back angle anchor without penetrating the first or second subsill portions. Moreover, a building membrane may be arranged between the subsill and the substrate and may include a membrane section interposing the second anchor portion and the second subsill portion. In such embodiments, the subsill is anchorable to the substrate via the back angle anchor without penetrating the building membrane.

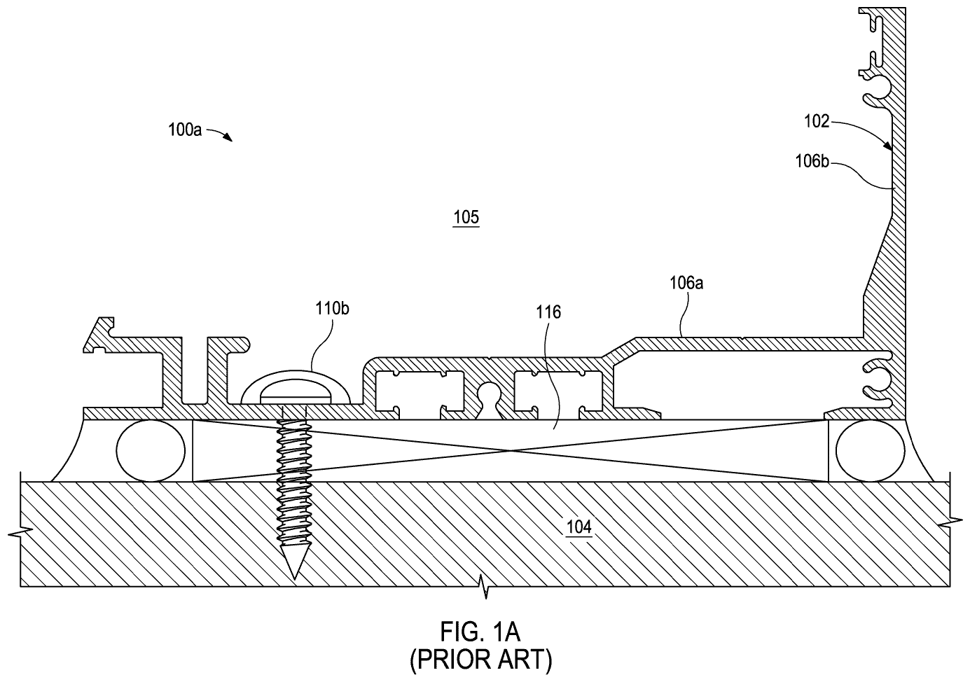

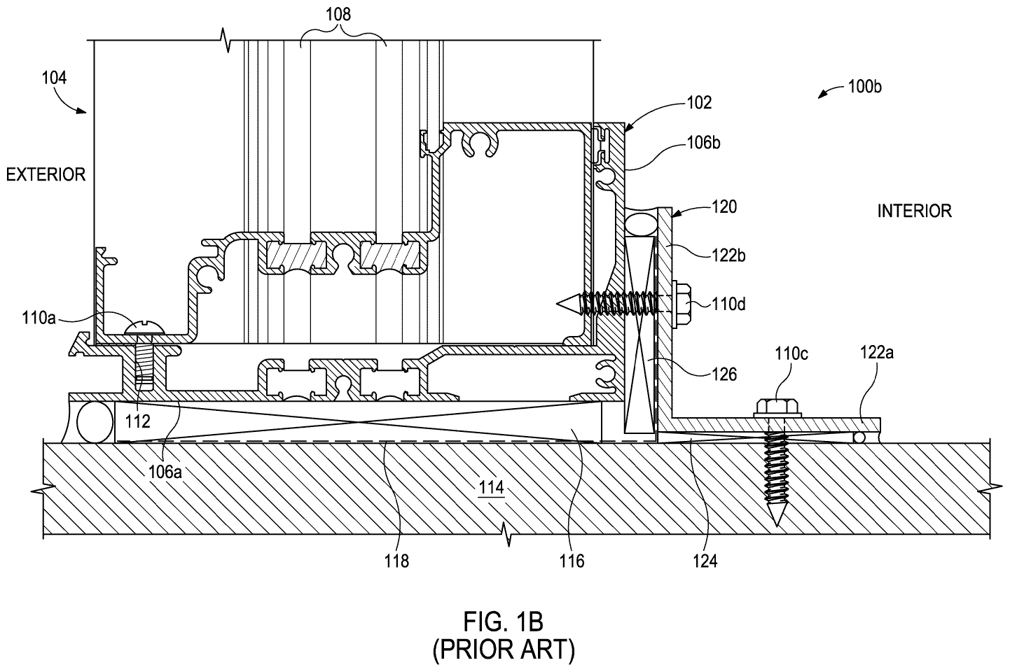

FIGS. 1A and 1B are schematic side views of prior art storefront fenestration systems 100a and 100b, respectively. As illustrated, each storefront fenestration system 100a, b includes a subsill 102 that includes a first or “horizontal” portion 106a and a second or “vertical” portion 106b that extends from the horizontal portion 106a at a substantially right angle (e.g., the horizontal and vertical portions 106a, b may be perpendicular to each other). The horizontal and vertical portions 106a, b, cooperatively define an opening or space 105 (FIG. 1A) sized to receive the fenestration system 104 (FIG. 1B).

Referring to FIG. 1B, the fenestration system 104 can comprise a glazing assembly or a door, for example. As a glazing assembly, the fenestration system 104 may include one or more discrete panels or “infills” 108 (two shown). The infills 108 may each comprise one or more panes of window glass, one or more panes of polycarbonate, or one or more panels of material that are clear, translucent, tinted, or opaque. The fenestration system 104 may be secured to the subsill 102 using one or more mechanical fasteners 110a (one shown) that penetrate a sill portion of the fenestration system 104 and are received within a fastener channel 112 defined the horizontal portion 106a of the subsill 102.

Before mounting the fenestration system 104 to the subsill 102, the subsill 102 is first anchored to an underlying substrate 114. In some applications, as shown in FIG. 1A, the subsill 102 is anchored to the substrate 114 using one or more mechanical fasteners 110b (one shown). More specifically, the mechanical fasteners 110b may penetrate the horizontal portion 106a of the subsill 102 and extend into the underlying substrate 114. The substrate 114 may include, but is not limited to, a concrete slab, wood, metal framing, brick exterior cladding, or any combination thereof.

In some installations, a shim 116 is arranged to interpose the subsill 102 (i.e., the horizontal portion 106a) and the substrate 114, and the mechanical fastener 110b also penetrates the shim 116. The shim 116 may be used to position the subsill 102 at a desired vertical height or location relative to the substrate 114. The shim 116 also provides for a space to apply sealant, as well as a method of maintaining the flatness of the subsill 102. The shim 116 may be made of a variety of materials including, but not limited to, wood, steel, aluminum, an elastomer, a plastic, or any combination thereof. Even though a silicone sealant may be applied over the head of the mechanical fastener 110b, penetrating the subsill 102 at the horizontal portion 106a creates a potential leak path in the system 110a.

Referring to FIG. 1B, the system 100b can also include a building membrane 118 (e.g., an air vapor barrier) arranged between the shim 116 and the upper surface of the substrate 114. The building membrane 118 is generally used to prevent the ingress of water into the interior of the system 100. Instead of anchoring the subsill 102 directly to the substrate 114 using the mechanical fastener 110b (FIG. 1A), the system 100b instead includes a back angle anchor 120 arranged within the interior of the system 100b and configured to help secure the subsill 102 to the substrate 114. As illustrated, the back angle anchor 120 provides a first or “horizontal” portion 122a and a second or “vertical” portion 122b that extends from the horizontal portion 122a at a substantially right angle (e.g., the horizontal and vertical portions 122a, b may be substantially perpendicular to each other). The back angle anchor 120 may be first anchored to the substrate 114 using one or more mechanical fasteners 110c (one shown) that penetrate the horizontal portion 122a and extend into the substrate 114. In some installations, a shim 124 may be arranged between the horizontal portion 122a and the top surface of the substrate 114. The shim 124 may be made of any of the materials mentioned herein with respect to the shim 116.

The subsill 102 may then be secured to the back angle anchor 120 using one or more mechanical fasteners 110d (one shown) that penetrate the vertical portion 122b of the back angle anchor 120 and extend into (and penetrate) the vertical portion 106b of the subsill 102. In such installations, a section of the building membrane 118 may extend vertically and generally interpose the vertical portions 106b, 122b between the subsill 102 and the back angle anchor 122, respectively. Moreover, in such installations, the mechanical fasteners 110d may also penetrate the vertical section of the building membrane 118, thereby introducing another possible leak point in the system 100. In some applications, a shim 126 may be arranged between the vertical portions 106b, 118b. The shim 126 may be made of any of the materials mentioned herein with respect to the shim 116.

According to embodiments of the present disclosure, an improved storefront fenestration system can include a subsill design that provides an anchor hook used to couple the subsill to the back angle anchor without affecting the air, water, or thermal performance of the system. More specifically, the back angle anchor can anchor the subsill to the substrate without any fasteners penetrating water drainage or collection areas. Instead, the anchor hook extends over a portion of the back angle anchor and is fastened to the back angle anchor without penetrating the main portions of the subsill or the building membrane. Moreover, a trim piece (or “stool”) may be used to hide the back angle anchor and the fasteners used to couple the subsill to the back angle anchor. The improved storefront fenestration systems described herein will allow for the installation of a storefront or window wall system without penetrating the subsill or building membrane.

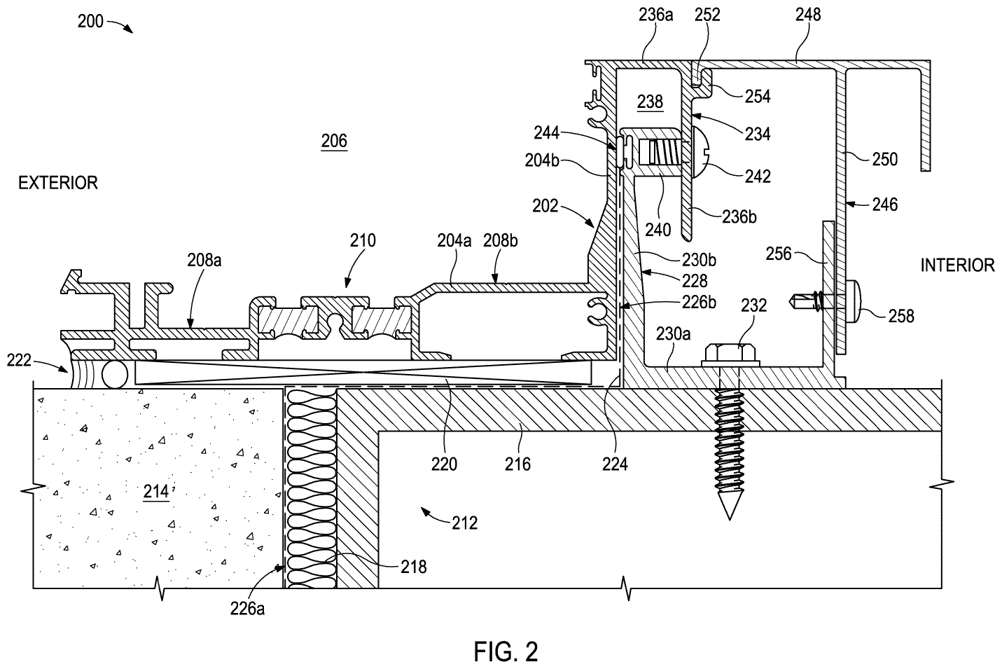

FIG. 2 is a schematic side view of an example storefront fenestration system 200, in accordance with the principles of the present disclosure. The storefront fenestration system 200 (hereafter “the system 200”) may be similar in some respects to the system 100 of FIG. 1, and therefore may be best understood with reference thereto. For instance, the system 200 includes a subsill 202 that may be similar in some respects to the subsill 102 of FIG. 1. As illustrated, the subsill 202 provides a first or “horizontal” subsill portion 204a and a second or “vertical” subsill portion 204b that extends from the horizontal subsill portion 204a. In some embodiments, the vertical subsill portion 204b may extend substantially perpendicular to the horizontal subsill portion 204a, but may alternatively extend at any other angle offset from perpendicular, without departing from the scope of the disclosure. The horizontal and vertical subsill portions 204a, b, cooperatively define an opening or space 206 sized to receive the fenestration system 104 (FIG. 1).

The subsill 202 may be made of a variety of rigid materials including, but not limited to, a metal (e.g., aluminum, steel, iron), a composite material (e.g., pultruded fiberglass), or any combination thereof. In some embodiments, as illustrated, the horizontal subsill portion 204a may comprise a composite profile. More specifically, the horizontal subsill portion 204a may comprise a first or “outer” section 208a and a second or “inner” section 208b, and the outer and inner sections 208a, b may be operatively coupled and otherwise separated by a thermal break 210. The thermal break 210 may be made of a thermally non-conductive material, such as a polymer (e.g., polyamide or polyurethane) or an elastomer, and may therefore interrupt thermal transfer between the outer and inner sections 208a, b.

When assembling the system 200, the subsill 202 may rest atop an underlying substrate 212. In some embodiments, the substrate 212 may be the same as or similar to the substrate 114 of FIG. 1, and therefore may be made of any of the materials listed herein with respect to the substrate 114. In at least one embodiment, the substrate 212 may comprise two or more dissimilar materials. As illustrated, for example, the substrate 212 may comprise a first substrate portion 214 made of a first material (e.g., brick exterior cladding) and a second substrate portion 216 made of a second material different from the first material (e.g., metal framing). In such embodiments, the subsill 202 may be arranged to extend across (span) portions of each of the first and second substrate portions 214, 216, thus being vertically supported by each substrate portion 214, 216. Moreover, in such embodiments, the system 200 may further include a layer of insulation 218 laterally (horizontally) interposing the first and second substrate portions 214, 216.

In some embodiments, a shim 220 may be arranged to interpose the subsill 202 (i.e., the horizontal subsill portion 204a) and the substrate 212. The shim 220 may be the same as or similar to the shim 116 of FIG. 1, and therefore may be made of any of the materials listed herein with respect to the shim 116. The shim 220 may be used to maintaining the flatness of the subsill 202 and position the subsill 202 at a desired vertical height or location relative to the substrate 212. Using the shim 220 will also result in a vertical gap being formed between the subsill 202 and the top surface of the substrate 212, which provide a space to apply a sealant or gasket. In at least one embodiment, for instance a backer rod and sealant 222 may be arranged (installed) in the gap and otherwise between the subsill 202 (i.e., the horizontal subsill portion 204a) and the top surface of the substrate 212 to provide a seal that occupies the gap.

In some embodiments, the system 200 may further include a building membrane 224 that may be arranged between the subsill 202 and the substrate 212 and, more particularly, between the shim 220 and the upper surface of the substrate 212. The building membrane 224 may be the same as or similar to the building membrane 118 of FIG. 1, and therefore may comprise an air vapor barrier generally used to prevent the ingress of air and water into the interior of the system 200. In some embodiments, as illustrated, a first or “lower” membrane section 226a of the building membrane 224 may extend vertically between and otherwise interpose the first substrate portion 214 of the substrate 212 and the insulation 218.

To secure the subsill 202 to the substrate 212, the system 200 may further include a back angle anchor 228 arranged within the interior of the system 200 (e.g., within the interior of the building where the system 200 is installed). The back angle anchor 228 may be made of a variety of rigid materials including, but not limited to, a metal (e.g., aluminum, steel, iron), a composite material, or any combination thereof. The back angle anchor 228 may be similar in some respects to the back angle anchor 120 of FIG. 1. For example, as illustrated, the back angle anchor 228 may provide a first or “horizontal” anchor portion 230a and a second or “vertical” anchor portion 230b that extends from the horizontal anchor portion 230a. In some embodiments, the vertical anchor portion 230b may extend substantially perpendicular to the horizontal anchor portion 230a, but may alternatively extend at any other angle offset from perpendicular, without departing from the scope of the disclosure.

To secure the subsill 202 to the substrate 212, the back angle anchor 228 may be first anchored to the substrate 212 using one or more mechanical fasteners 232 (one shown), such as anchor bolts or screws. As illustrated, the mechanical fasteners 232 penetrate the horizontal anchor portion 230a and extend into the substrate 212. Once the back angle anchor 228 is anchored to the substrate 212, the building membrane 224 is attached to the substrate 212 and the back angle anchor 228. The subsill 202 may then be attached to the back angle anchor 228, thereby securing the subsill 202 to the substrate 212.

More specifically, as illustrated, the subsill 202 may include or otherwise define a subsill extension or “anchor hook” 234 that extends from the vertical subsill portion 204b of the subsill 202, and the subsill 202 may be secured to the back angle anchor 228 at the anchor hook 234. In some embodiments, the anchor hook 234 may comprise an integral extension of the subsill 202. In such embodiments, the anchor hook 234 may be integrally formed along with the remaining portions of the subsill 202. In other embodiments, however, the anchor hook 234 may comprise a separate component part that can be attached to the subsill 202, without departing from the scope of the disclosure.

As illustrated, the anchor hook 234 includes a first or “horizontal” extension 236a extending from the vertical subsill portion 204b, and a second or “vertical” extension 236b extending from the horizontal extension 236a. In some embodiments, the horizontal extension 236a extends substantially perpendicular from the vertical subsill portion 204b, and the vertical extension 236b extends substantially perpendicular from the horizontal extension 236a. In other embodiments, however, one or both of the horizontal and vertical extensions 236a, b may alternatively extend at an angle offset from perpendicular, without departing from the scope of the disclosure.

The vertical subsill portion 204b and the horizontal and vertical extensions 236a, b may cooperatively define a subsill cavity 238 sized to receive at least a portion of the vertical anchor portion 230b of the back angle anchor 228. In some embodiments, as illustrated, the subsill cavity 238 may comprise a generally U-shaped channel, but could otherwise exhibit other shapes, without departing from the scope of the disclosure.

An attachment receptor 240 may be provided on the vertical anchor portion 230b and may be configured to receive a mechanical fastener 242 that secures the subsill 202 to the back angle anchor 228. More specifically, the mechanical fastener 242 may penetrate the vertical extension 236b to be received within the attachment receptor 240. Tightening the mechanical fastener 242 will correspondingly secure the subsill 202 to the back angle anchor 228 via the anchor hook 234. In at least one embodiment, the attachment receptor 240 may comprise an elongate, and horizontally-extending channel that extends the longitudinal length of the subsill 202. This may prove advantageous in allowing the mechanical fastener 242 to locate and be received within the attachment receptor 240 along any portion of the horizontal longitudinal length of the subsill 202. In one or more embodiments, there will be at least one mechanical fastener 242 per length of the subsill 102 (e.g., the length of the subsill 102 is limited to fifteen feet, then a splice will be required every fifteen feet). In at least one application, the mechanical fastener 242 will be located at about the midspan of the subsill 102 to allow for thermal expansion and contraction at the splice joints.

In some embodiments, as illustrated a gasket or seal 244 may be arranged between the vertical subsill portion 204b of the subsill 202 and the vertical anchor portion 230b of the back angle anchor 228. In particular, the seal 244 may be arranged at and otherwise coupled to the attachment receptor 240. The seal 244 may help prevent the ingress of water or air into the interface between the vertical subsill portions 204b, 230b.

In some embodiments, as illustrated, the building membrane 224 may include a second or “upper” membrane section 226b that extends vertically and generally interposes the vertical subsill portion 204b of the subsill 202 and the vertical anchor portion 230b of the back angle anchor 228. Because the mechanical fastener 242 secures the subsill 202 to the back angle anchor 228 at the attachment receptor 240, the mechanical fastener 242 does not penetrate the vertical subsill portion 204b of the subsill 202, and, therefore, also does not penetrate the building membrane 224 (e.g., the upper membrane section 226b). Accordingly, the subsill 202 is able to be secured to the substrate 212 without penetrating the main structure of the subsill 202 (i.e., the horizontal or vertical subsill portions 204a, b) or any portion of the building membrane 224. Rather, the mechanical fastener 242 is located within the interior of the system 200, and thereby outside of the water collection area, and merely penetrates the anchor hook.

In some embodiments, as illustrated, the system 200 may further include a stool trim 246, alternately referred to as a stool, a trim cover, or a trim piece. The stool trim 246 may be configured to be attached to portions of the subsill 202 and the back angle anchor 228 to generally hide the mechanical fastener 242 and the attachment between the anchor hook 234 and the attachment receptor 240. As illustrated, the stool trim 246 may include a stool base 248 and a stool leg 250 that extends from the stool base 248.

The stool base 248 may provide or otherwise define an engagement member 252 that may be received by a corresponding engagement receptor 254 provided by the subsill 202 and, more particularly, by the anchor hook 234. In at least one embodiment, the engagement member 252 may be received within the engagement receptor 254 via an interference fit, but could alternatively be secured within the engagement receptor 254 via a mechanical engagement (e.g., a ratchet engagement) or using an adhesive (e.g., a silicon adhesive). In other embodiments, the engagement member 252 may alternatively be provided on the anchor hook 234, and the engagement receptor 254 may instead be provided on the stool base 248, without departing from the scope of the disclosure.

The stool leg 250 may be configured to be secured to the back angle anchor 228 at an anchor leg 256 that forms part of the back angle anchor 228. More specifically, the anchor leg 256 may extend from the horizontal anchor portion 230a of the back angle anchor 228. In some embodiments, the stool leg 250 may extend substantially perpendicular from the stool base 248, and the anchor leg 256 may extend substantially perpendicular from the horizontal anchor portion 230a of the back angle anchor 228. In other embodiments, however, the stool leg 250 and the anchor leg 256 may extend at angles offset from perpendicular from the stool base 248 and the horizontal anchor portion 230a, respectively. The stool leg 250 may be secured to the anchor leg 256 using one or more mechanical fasteners 258 (one shown). In at least one embodiment, the mechanical fasteners 258 may be self-tapping screws, but could alternatively comprise other types of mechanical fasteners, without departing from the scope of the disclosure.

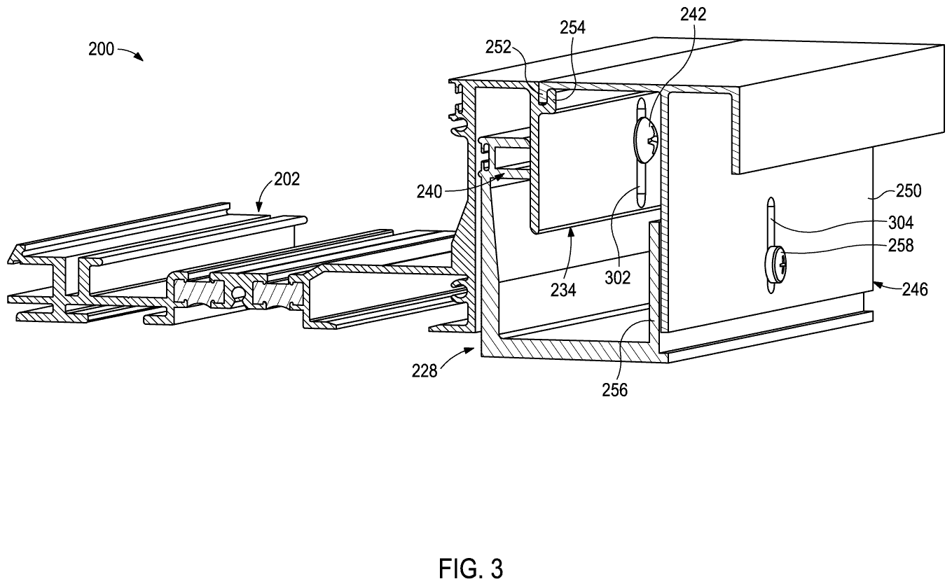

FIG. 3 is an isometric view of the system 200, according to one or more embodiments of the disclosure. In some installations, the substrate 212 (FIG. 2) may not be flat or uniform, or the shim 220 (FIG. 2) arranged between the substrate 212 and the subsill 202 may cause the subsill 202 to vertically misalign with the back angle anchor 228. To account for differences in vertical height between the subsill 202 and the back angle anchor 228, and also to account for vertical building movement and tolerances, the anchor hook 234 may define a vertical slot 302 sized to receive the mechanical fastener 242. More specifically, the vertical slot 302 may be defined in the vertical extension 236b, and the mechanical fastener 242 may extend through the vertical slot 302 to be received within the attachment receptor 240. The vertical slot 302 may prove advantageous in allowing the subsill 202 to be installed at a variety of heights relative to the back angle anchor 228. Once the proper height is achieved, the mechanical fastener 242 can be fully tightened to secure the subsill 202 to the back angle anchor 228.

Similarly, in some embodiments, the stool trim 246 may define a vertical slot 304 sized to receive the mechanical fastener 258 to account for differences in vertical height between the subsill 202 and the back angle anchor 228, and to further account for vertical building movement and tolerances. The vertical slot 304 may be defined in the stool leg 250 and the mechanical fastener 258 may extend through the vertical slot 304 to penetrate the anchor leg 256 of the back angle anchor 228. Once the proper height is achieved and the engagement member 252 is properly received by the engagement receptor 254, the mechanical fastener 258 can be fully tightened to secure the stool trim 246 to the back angle anchor 228.

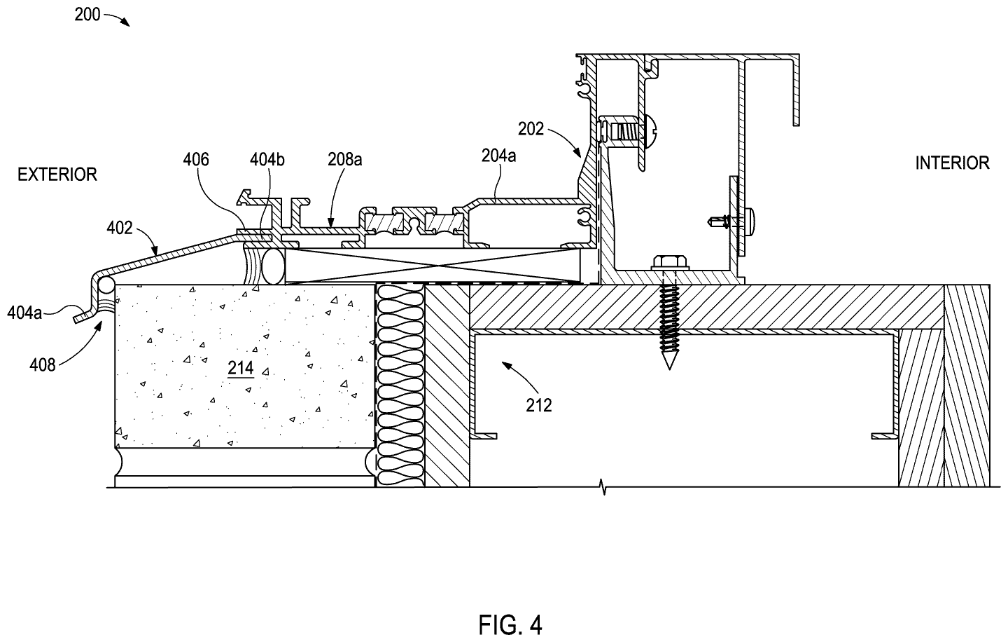

FIG. 4 is another schematic side view of the system 200, according to one or more additional embodiments of the present disclosure. In some embodiments, as illustrated, the system 200 may further include brake metal flashing 402 arranged on the exterior of the system 200 and capable of accommodating any building condition. As used herein, the term “brake metal flashing” refers to a thin sheet of metal (e.g., aluminum) that is bent into desired bend-lines and shapes to fit, contour, and flash around building structures.

In the illustrated embodiment, the brake metal flashing 402 may include a first or “lower” end 404a and a second or “upper” end 404b opposite the lower end 404a. The upper end 404b may be configured to be received within an engagement receptor 406 included on and otherwise defined by the subsill 202, and more particularly, the horizontal subsill portion 204a, and even more particularly, the outer section 208a of the horizonal portion 204a. The engagement receptor 406 may comprise a slot or elongate channel that extends the length of the subsill 202. In some embodiments, the upper end 404b of the brake metal flashing 402 may be secured within the engagement receptor 406 using one or more mechanical fasteners (not shown). In other embodiments, however, the upper end 404b may be secured within the engagement receptor 406 using an adhesive, such as a silicone sealant.

The brake metal flashing 402 may be arranged at an angle such that water received on the top (exposed surface) of the brake metal flashing 402 will be diverted away from the building. In at least one embodiment a backer rod and sealant 408 may be arranged between the lower end 404a and the substrate 212. More specifically, the seal 408 may interpose the lower end and the substrate 212, such as the first substrate portion 214 of the substrate 212. The seal 408 may be configured to prevent the influx or migration of air and water into the system 200 below the subsill 202.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

1. A fenestration system, comprising:
a back angle anchor providing a first anchor portion and a second anchor portion extending from the first anchor portion and providing an attachment receptor, the back angle anchor being securable to an underlying substrate at the first anchor portion;
a subsill providing a first subsill portion and a second subsill portion extending from the first subsill portion; and
an anchor hook extending from the second subsill portion and defining a subsill cavity sized to receive the attachment receptor,
wherein the subsill is attached to the back angle anchor using one or more mechanical fasteners penetrating the anchor hook and received within the attachment receptor, and
wherein the subsill is anchorable to the substrate via the back angle anchor without penetrating the first or second subsill portions.

2. The fenestration system of claim 1, further comprising a building membrane arrangeable between the subsill and the substrate and including a membrane section interposing the second anchor portion and the second subsill portion,
wherein the subsill is anchorable to the substrate via the back angle anchor without penetrating the building membrane.

3. The fenestration system of claim 2, wherein the substrate comprises a first substrate portion made of a first material and a second substrate portion made of a second material different from the first material, the fenestration system further comprising a layer of insulation laterally interposing the first and second substrate portions,
wherein the membrane section comprises a first membrane section, and the building membrane further includes a second membrane section interposing the first substrate portion and the layer of insulation.

4. The fenestration system of claim 3, wherein the subsill is arranged to extend across portions of each of the first and second substrate portions.

5. The fenestration system of claim 1, wherein the anchor hook comprises a first extension extending from the second subsill portion and a second extension extending from the first extension.

6. The fenestration system of claim 5, wherein the second extension defines a vertical slot sized to receive the one or more mechanical fasteners, the vertical slot allowing a height of the subsill to be adjusted relative to the back angle anchor prior to securing the one or more mechanical fasteners.

7. The fenestration system of claim 1, further comprising a stool trim operatively coupleable to the anchor hook and the back angle anchor and thereby hiding attachment between the anchor hook and the attachment receptor.

8. The fenestration system of claim 7, wherein the stool trim includes:
a stool base; and
a stool leg extending from the stool base and operatively coupleable to an anchor leg extending from the first anchor portion with one or more additional mechanical fasteners.

9. The fenestration system of claim 8, wherein the stool leg defines a vertical slot sized to receive the one or more additional mechanical fasteners, the vertical slot allowing a height of the subsill to be adjusted relative to the back angle anchor prior to securing the one or more additional mechanical fasteners.

10. The fenestration system of claim 1, further comprising brake metal flashing arrangeable on an exterior of the system and including an end operatively coupleable to the first subsill portion.

11. The fenestration system of claim 1, further comprising a fenestration operatively couplable to the subsill and receivable within a space cooperatively defined by the first and second subsill portions.

12. The fenestration system of claim 1, wherein the attachment receptor comprises an elongate channel extending a longitudinal length of the subsill.

13. The fenestration system of claim 1, wherein the subsill comprises a composite profile such that the first portion includes:
a first section;
a second section; and
a thermal break that operatively couples the first and second sections.

14. A method of assembling a fenestration system, comprising:
securing a back angle anchor to an underlying substrate, the back angle anchor providing a first anchor portion secured to the substrate and a second anchor portion extending from the first anchor portion and providing an attachment receptor;
arranging a subsill atop the substrate, the subsill providing:
a first subsill portion;
a second subsill portion extending from the first subsill portion; and
an anchor hook extending from the second subsill portion and defining a subsill cavity;
receiving the attachment receptor into the subsill cavity as the subsill is arranged atop the substrate; and
attaching the subsill to the back angle anchor using one or more mechanical fasteners penetrating the anchor hook and received within the attachment receptor,
wherein the subsill is anchored to the substrate via the back angle anchor without penetrating the first or second subsill portions.

15. The method of claim 14, further comprising:
arranging a building membrane between the subsill and the substrate; and
arranging a membrane section of the building membrane between the second anchor portion and the second subsill portion,
wherein the subsill is anchored to the substrate via the back angle anchor without penetrating the building membrane.

16. The method of claim 14, wherein the anchor hook comprises a first extension extending from the second subsill portion and a second extension extending from the first extension, and wherein the second extension defines a vertical slot sized to receive the one or more mechanical fasteners, the method further comprising:
adjusting a height of the subsill relative to the back angle anchor; and
securing the one or more mechanical fasteners to the attachment receptor via the vertical slot once the height is adjusted.

17. The method of claim 14, further comprising coupling a stool trim to the anchor hook and the back angle anchor and thereby hiding attachment between the anchor hook and the attachment receptor.

18. The method of claim 17, wherein the stool trim includes a stool base, and a stool leg extending from the stool base and defining a vertical slot, and wherein coupling the stool trim to the anchor hook and the back angle anchor comprises:
adjusting a height of the subsill relative to the back angle anchor; and
securing one or more additional mechanical fasteners to an anchor leg extending from the first anchor portion via the vertical slot and once the height is adjusted.

19. The method of claim 14, further comprising securing brake metal flashing to the first subsill portion on an exterior of the system.

20. The method of claim 14, further comprising:
receiving a fenestration within a space cooperatively defined by the first and second subsill portions; and
operatively coupling the fenestration to the subsill.
